(19) United States
(12) Patent Application Publication
(10) Pub. No.: US 2007/0282837 A1
(43) Pub. Date: Dec. 6, 2007

(54) Measuring the Performance of Database Stored Procedures in a Multi-Tasking Execution Environment

(75) Inventor: Paul Fredric Klein, Newbury Park, CA (US)

Correspondence Address: INTERNATIONAL BUSINESS MACHINES CORP., IP LAW, 555 BAILEY AVENUE, J46/G4, SAN JOSE, CA, 95141, US

(73) Assignee: INTERNATIONAL BUSINESS MACHINES CORPORATION, Armonk, NY (US)

(21) Appl. No.: 11/421,326

(22) Filed: May 31, 2006

(51) Int. Cl. G06F 7/00

(52) U.S. Cl. 707/7

(57) ABSTRACT

Various embodiments of a computer-implemented method, system and computer program product are provided. One or more components executing one or more stored procedures are identified. The stored procedures have stored procedure identifiers, respectively. Database data that is associated with at least one of the one or more stored procedures is gathered from a database management system. The database data comprises at least one of the stored procedure identifiers, at least one execution start time and at least one execution end time. Component-based data that is associated with the one or more components is gathered. The component-based data comprises at least one of the stored procedure identifiers and at least one sample time. The database data and the component-based data are correlated based on a particular one of the stored procedure identifiers, at least one execution start time, at least one execution end time, and at least one sample time.

### BACKGROUND OF THE INVENTION

1.0 Field of the Invention

This invention relates to database management systems; and in particular, this invention relates to measuring the performance of database stored procedures in a multi-tasking execution environment.

2.0 Description of the Related Art

Database management systems organize data and allow that data to be accessed quickly and conveniently. There are various types of database management systems, such as relational database management systems, hierarchical database management systems, and network database management systems.

A query language is typically used to access the data in the database management system. Database application programs can be written using the query language to access the data stored in the database. For example, the Structured Query Language (SQL) is one well-known query language. The database application program may be written using SQL or other languages, for example, COBOL, PL/1, Java, and C, to access the data stored in the database.

A module, referred to as a “stored procedure”, can be used to access the data in one or more database management systems. The stored procedure may be a program or a script file, and is physically stored at or in a database management system, typically the database management system which the stored procedure will access. The database application program may invoke or call one or more stored procedures. The stored procedure typically comprises one or more data requests, or calls to other stored procedures that issue data requests, for data from one or more databases. For example, the stored procedure may comprise one or more SQL statements to retrieve data from the database management system. Alternately, the stored procedure may be written in a language, for example, COBOL, PL/1, C or Java, to retrieve data from the database management system. Because stored procedures allow the data request logic to be stored and processed locally at the database management system from which data is being retrieved, stored procedures can reduce the amount of data which is transferred over a network. A requester, for example, a stored procedure, at one database management system may invoke a stored procedure which is stored remotely at another database management system. When the stored procedure at the remote database management system completes its processing, the stored procedure sends its result over a network to the requester. In this way, the amount of data returned to the requester may be reduced because the result, rather than all the retrieved data, is returned to the requester.

Stored procedures can be shared with multiple database application programs. For example, a stored procedure that has database request logic to find an employee's Social Security Number can be shared with database application programs used by the Human Resources, the Benefits, and the Retirement departments by calling the stored procedure using the stored procedure's name. Therefore, stored procedures may become a knowledge trust of enterprise information gathering.

In some enterprises, much of the application processing may be performed at the databases using stored procedures, and not in the applications themselves. In large execution environments, this may place a significant burden on the databases and database performance may degrade. In addition, stored procedures may be executed in a multi-tasking or multi-processing environment. In a multi-tasking environment, a stored procedure can execute in a different address space at each invocation. For example, in the International Business Machines (IBM) z/OS operating system environment, the Work Load Manager (WLM) assigns a stored procedure to an address space for execution, and the stored procedures are executed in one or more “Stored Procedure Address Spaces” (SPASs) or Enclaves, under one or more “Task Control Blocks” (TCBs). Therefore there is a need for a technique to gather performance data that is associated with the execution of the stored procedures in an address space.

In a distributed environment, a stored procedure may invoke other stored procedures which are executed on a remote computer system. Therefore, there is a need for a technique to identify the sequence of execution of stored procedures in the distributed environment. There is also a need to gather performance data that is associated with the execution of the stored procedures in the distributed environment.

### SUMMARY OF THE INVENTION

To overcome the limitations in the prior art described above, and to overcome other limitations that will become apparent upon reading and understanding the present specification, various embodiments of a computer-implemented method, system and computer program product are provided. One or more components executing one or more stored procedures are identified. The stored procedures have stored procedure identifiers, respectively. Database data that is associated with at least one of the one or more stored procedures is gathered from a database management system. The database data comprises at least one of the stored procedure identifiers, at least one execution start time and at least one execution end time. Component-based data that is associated with the one or more components is gathered. The component-based data comprises at least one of the stored procedure identifiers and at least one sample time. The database data and the component-based data are correlated based on a particular one of the stored procedure identifiers, the at least one execution start time, the at least one execution end time, and the at least one sample time that is associated with the particular one of the stored procedure identifiers.

In various embodiments, the component-based data also comprises one or more performance measures. The database data and the component-based data are correlated based on the at least one sample time that is associated with the particular one of the stored procedure identifiers being within the at least one execution start time and the at least one execution end time that is associated with the particular one of the stored procedure identifiers.

In some embodiments, at least one child stored procedure of a particular one of the stored procedures that is associated with the particular one of the stored procedure identifiers is identified based on a content of the particular one of the stored procedures. The at least one child stored procedure has a child stored procedure identifier. The database data and component-based data are correlated also based on the child stored procedure identifier, and a sample time that is associated with the child stored procedure identifier.

In some embodiments, at least one of the components is on a different data processing system from other components.

In this way, one or more performance measures that are associated with the execution of the stored procedures are gathered. In addition, the sequence of execution of stored procedures is identified in a multi-tasking environment, and in some embodiments, a distributed environment.

### BRIEF DESCRIPTION OF THE DRAWINGS

The teachings of the present invention can be readily understood by considering the following description in conjunction with the accompanying drawings, in which:

FIG. 1 depicts a high level flowchart of an embodiment of the present invention;

FIG. 2 depicts a flowchart of an alternate embodiment of the present invention;

FIG. 3 depicts a diagram of an embodiment of a stored procedure component table which is associated with metric and performance tables;

FIG. 4 depicts a diagram of an embodiment of a performance table of FIG. 3;

FIG. 5 depicts a diagram of an embodiment of a metric table of FIG. 3;

FIG. 6 depicts a flowchart of an embodiment of collecting accounting record and performance data;

FIG. 7 depicts a flowchart of an embodiment of the step of gathering accounting record data of FIG. 6;

FIG. 8 depicts a flowchart of an embodiment of the step of gathering performance data of a particular component, that is, a SPAS, of FIG. 6;

FIG. 9 depicts a flowchart of an embodiment of the steps which correlate and present accounting record and performance data of FIG. 1;

FIG. 10 comprises FIGS. 10A and 10B which collectively depict a flowchart of another embodiment of the steps which correlate and present accounting record and performance data of FIG. 1;

FIG. 11 depicts a flowchart of an embodiment of the steps which correlate and present accounting record and performance data of FIG. 2;

FIG. 12 depicts a flowchart of an embodiment of the step which updates the stored procedure profile data structure with performance measures and, in some embodiments, metrics, which are associated with a primary stored procedure identifier of FIG. 11;

FIG. 13 comprises FIGS. 13A and 13B which collectively depict a flowchart of an embodiment of the step which updates the stored procedure profile data structure associating the primary stored procedure identifier with a child stored procedure identifier based on the stored procedure identifiers, start and end times of the primary stored procedure and the sample time of FIG. 11;

FIG. 14 depicts a flowchart of another embodiment of the step that correlates accounting record and performance data of a stored procedure of FIG. 2;

FIG. 15 depicts an illustrative stored procedure component table, illustrative metric tables and illustrative performance tables;

FIG. 16 depicts an illustrative stored procedure profile data structure;

FIG. 17 depicts an exemplary graphical user interface presenting the illustrative data of FIG. 15 which is correlated in accordance with the flowchart of FIG. 2;

FIG. 18 depicts an illustrative data processing system which uses various embodiments of the present invention; and

FIG. 19 depicts an illustrative distributed computing environment using various embodiments of the present invention.

To facilitate understanding, identical reference numerals are used, where possible, to designate identical elements that are common to some of the figures.

### DETAILED DESCRIPTION

After considering the following description, those skilled in the art will clearly realize that the teachings of the various embodiments of the present invention can be utilized to improve performance of a database management system. Various embodiments of a computer-implemented method, system and computer program product are provided. One or more components executing one or more stored procedures are identified. The stored procedures have stored procedure identifiers, respectively. Database data that is associated with at least one of the one or more stored procedures is gathered from a database management system. The database data comprises at least one of the stored procedure identifiers, at least one execution start time and at least one execution end time. Component-based data that is associated with the one or more components is gathered. The component-based data comprises at least one of the stored procedure identifiers and at least one sample time. The database data and the component-based data are correlated based on a particular one of the stored procedure identifiers, the at least one execution start time, the at least one execution end time, and the at least one sample time that is associated with the particular one of the stored procedure identifiers.

In various embodiments, the component-based data also comprises one or more performance measures. The database data and the component-based data are correlated based on the at least one sample time that is associated with the particular one of the stored procedure identifiers being within the at least one execution start time and the at least one execution end time that is associated with the particular one of the stored procedure identifiers.

In some embodiments, at least one child stored procedure of a particular one of the stored procedures that is associated with the particular one of the stored procedure identifiers is identified based on a content of the particular one of the stored procedures. The at least one child stored procedure has a child stored procedure identifier. The database data and component-based data are correlated also based on the child stored procedure identifier, and a sample time that is associated with the child stored procedure identifier.

In some embodiments, at least one of the components is on a different computer system from other components. In various embodiments, the components are stored procedure address spaces; in other embodiments, the components are processes.

A component may also be referred to as a unit of work, and comprises an address space which is used to execute a program module. For example, in some operating system environments, such as the IBM z/OS operating system environment, a component is an address space. In another example, in some other operating system environments, such as a UNIX operating system environment, a component is a process. A component on which a stored procedure is executed is also referred to as a stored procedure component (SPC).

Various embodiments identify the components on which stored procedures are executed, gather database data that is associated with stored procedures from the database management system, gather component-based performance data that is associated with the stored procedures which are being executed on the components, and correlate the database data from the database management system with the component-based performance data that is associated with the stored procedure. In various embodiments, the result of the correlation is presented.

A stored procedure may call another stored procedure. A stored procedure which calls another stored procedure is referred to as a parent stored procedure. A stored procedure which is called by another stored procedure is referred to as a child stored procedure. A parent stored procedure is a direct parent of a child stored procedure that the parent stored procedure calls, and is indirectly a parent of any stored procedures called by its child stored procedure. A stored procedure may be both a child and a parent stored procedure. In some embodiments, any child stored procedures which are called by a primary stored procedure, either directly or indirectly, are identified based on the content of the parent and child stored procedures, and the performance data of the child stored procedures is correlated with the parent stored procedure. In this way, a profile which provides performance data of stored procedures which may be executed concurrently, such as nested stored procedures, can be generated.

A database environment comprises one or more database management systems which are executing on one or more computer systems. The computer system typically executes an operating system which provides an operating system environment. The database management system typically executes within the operating system environment. In some computer systems, multiple database management systems may be executed concurrently. A database management system may also be referred to as a database subsystem. Various embodiments of the present invention can be used in an operating system environment comprising a single database management system and in an operating system environment comprising multiple database management systems. In addition, various embodiments of the present invention can be used in distributed environments comprising a plurality of computer systems executing database management systems.

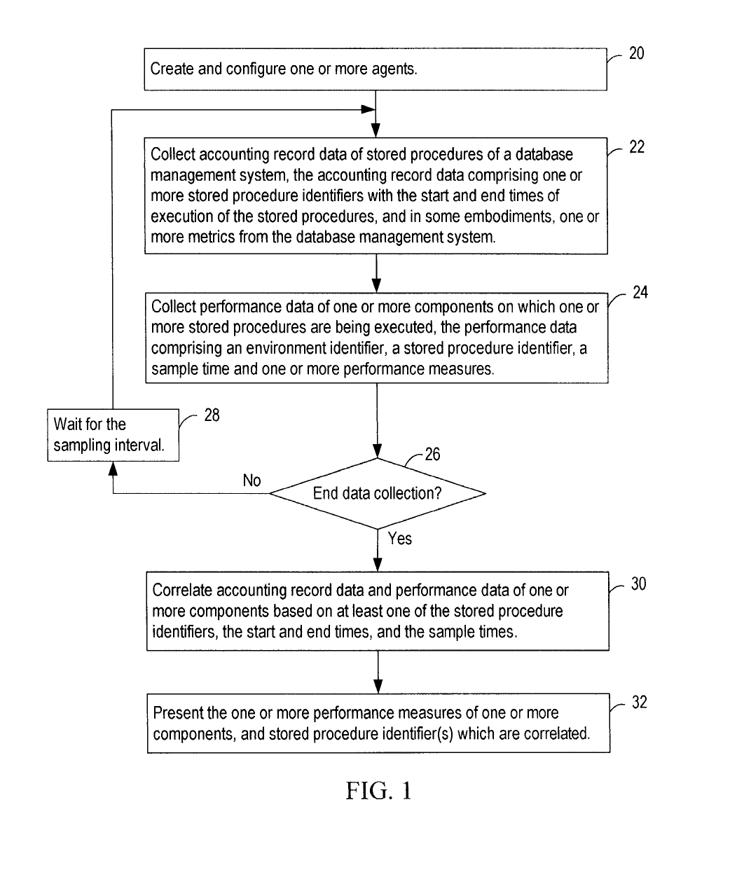

FIG. 1 depicts a high-level flowchart of an embodiment of the present invention. In step 20, one or more agents are created and configured.

The agent typically executes on the same computer system as the database management system that the agent is monitoring. In some distributed embodiments, a primary agent is created at a primary database management system, and additional agents are created and configured to execute at remote database management systems on remote computer systems which have at least one stored procedure which is called by one of the stored procedures of the primary database management system. The agent at the primary database management system communicates with the other agents to request and receive performance data. In other embodiments, additional agents are not created at the remote database management systems.

The agent is defined as a sampling agent. The agent sleeps for a sampling interval, that is, a predetermined amount of time before waking-up, that is, becoming active, to collect data. The sampling interval is typically selected to be sufficiently small, such as seconds, so as to capture performance data about stored procedures which execute quickly as well as stored procedures which execute for a long period of time. In various embodiments, the sampling interval is configurable. In some embodiments, a user defines the sampling interval. In various embodiments, a user also defines a monitoring interval which is an amount of time that the agent monitors the stored procedure(s). In other embodiments, the monitoring interval is a predetermined number of wake cycles of the agent.

In various embodiments, the agent receives a database subsystem ID as part of its configuration, and will only monitor that database subsystem.

In some embodiments, the database management system is configured to trace database performance. For example, in embodiments using the DB2 database management system, DB2 database management system tracing is activated for classes 1, 2, 3, 7 and 8.

In various embodiments, the agent performs steps 22-32 of FIG. 1. The agent periodically wakes up at the specified sampling interval and collects performance data.

In step 22, the agent collects accounting record data of stored procedures of a database management system. Database management systems typically have a logging and accounting facility which has accounting records. Each stored procedure has a stored procedure identifier, for example, a name. The accounting record data comprises one or more stored procedure identifiers with the start and end times of execution of the stored procedure, and, in some embodiments, one or more stored procedure metrics of the database management system. Initially, the accounting record data is retrieved from those accounting records which are created after the start of the execution of the agent. After collecting the initial accounting record data, the accounting record data is retrieved from those accounting records which are created after the previous sampling interval. The accounting record data is a type of database data; in other embodiments, other types of database data are collected.

In step 24, the agent collects performance data of one or more components on which one or more stored procedures are being executed. The performance data comprises an environment identifier, a stored procedure identifier, a sample time, and one or more performance measures. The agent identifies one or more components that execute at least one stored procedure. Each component has a component identifier. One component identifier is associated with at least one of the stored procedure identifiers. In some embodiments, one component identifier is associated with multiple stored procedure identifiers.

In step 26, the agent determines whether to end data collection. In some embodiments, data collection is ended after the monitoring interval elapses.

In response to the agent determining in step 26, that data collection is not ended, the agent proceeds to step 28. In step 28, the agent waits for the sampling interval, and proceeds to step 22. In response to the agent determining in step 26, that data collection is ended, the agent proceeds to step 30.

In step 30, the agent correlates accounting record data and performance data of one or more components based on at least one of the stored procedure identifiers, the start and end times, and the sample times. In this way, performance measures which are associated with a component, such as central processing unit (CPU) utilization and memory usage, are correlated with an execution of a stored procedure as indicated by the accounting records.

In step 32, the agent presents the one or more performance measures of one or more components, and one or more stored procedure identifier(s) which are correlated. In various embodiments, the environment identifier associated with the stored procedure identifier is also presented. In some embodiments, the accounting record data, such as the start time, end time, row identifier and at least one metric, of an accounting record that is correlated is also presented.

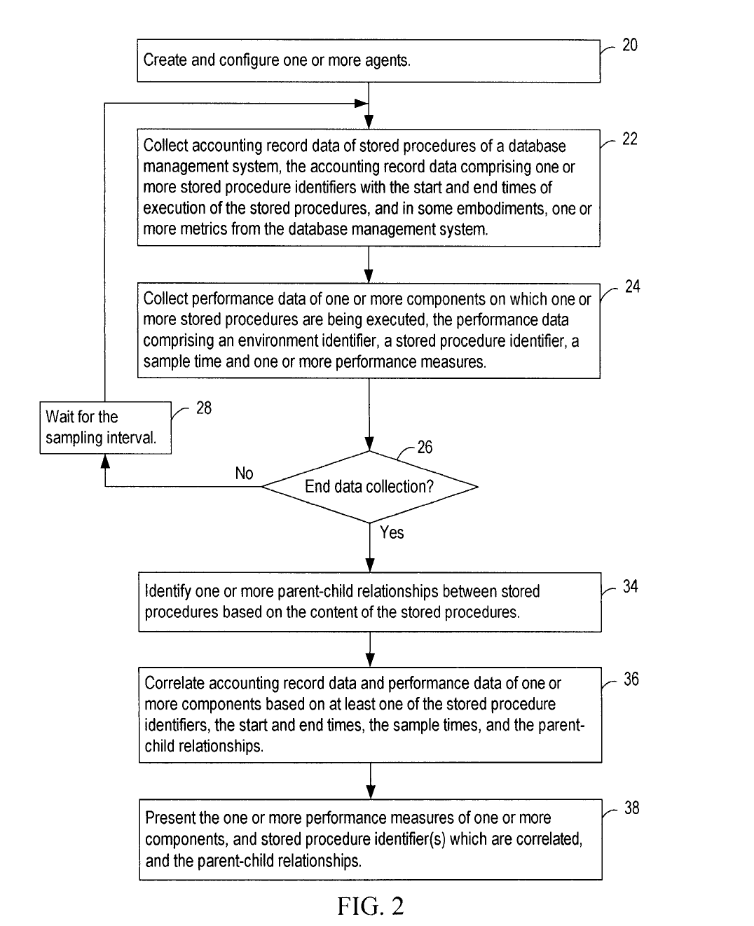

FIG. 2 depicts a flowchart of an alternate embodiment of the present invention. In the embodiment of FIG. 2, the sequence of execution of stored procedures which are nested is identified. In addition, the accounting record data and performance data are correlated based on the sample time, start and end times, and the content of the primary stored procedure and any child stored procedures. In some embodiments, the content of a stored procedure refers to the SQL code, or in other embodiments, the code of another programming language. In some embodiments, the agent performs steps 22-28, and 34-38 of FIG. 2. Steps 22-28 of FIG. 2 are the same as in FIG. 1 and will not be further described.

In step 34, the agent identifies one or more parent-child relationships between stored procedures based on the content of the stored procedures. For example, the content of a stored procedure is retrieved and analyzed to identify any stored procedure calls thereby identifying child stored procedures. The content of any child stored procedures is retrieved and analyzed to identify additional child stored procedures, until no additional child stored procedures are identified.

In step 36, the agent correlates accounting record data and performance data of one or more components based on at least one of the stored procedure identifiers, the start and end times, the sample times, and the parent-child relationships. The sequence of execution of the child stored procedures is identified, and, in some embodiments, the performance measures associated with the execution of the child stored procedures are rolled up to the parent stored procedure(s).

In various embodiments, the execution of a child stored procedure is correlated with the execution of its parent stored procedure(s). In this way, the sequence of execution of stored procedures is identified, and the performance of the stored procedures can be measured as a stored procedure calls child stored procedures which execute on different components, and in some embodiments, on different computer systems.

In step 38, the agent presents one or more performance measures of one or more components, and one or more stored procedure identifier(s) which are correlated, and the parent-child relationships. In various embodiments, the sequence of execution of the stored procedures is presented. In some embodiments, the stored procedure identifiers, with their performance measures, are presented graphically; in other embodiments, the stored procedure identifiers with their performance measures are presented as text in a report. In some embodiments, the performance measures are omitted. In other embodiments, accounting record data which is correlated is also presented.

Various embodiments will be described with respect to the IBM DB2 distributed database executing on an IBM z/OS operating system with the execution of the stored procedures being managed by the IBM Work Load Manager. However, in other embodiments, other operating systems, database management systems, and work load managers may be used. Various embodiments will be described with respect to components such as the stored procedure address space of z/OS; in other embodiments, other types of components may be used.

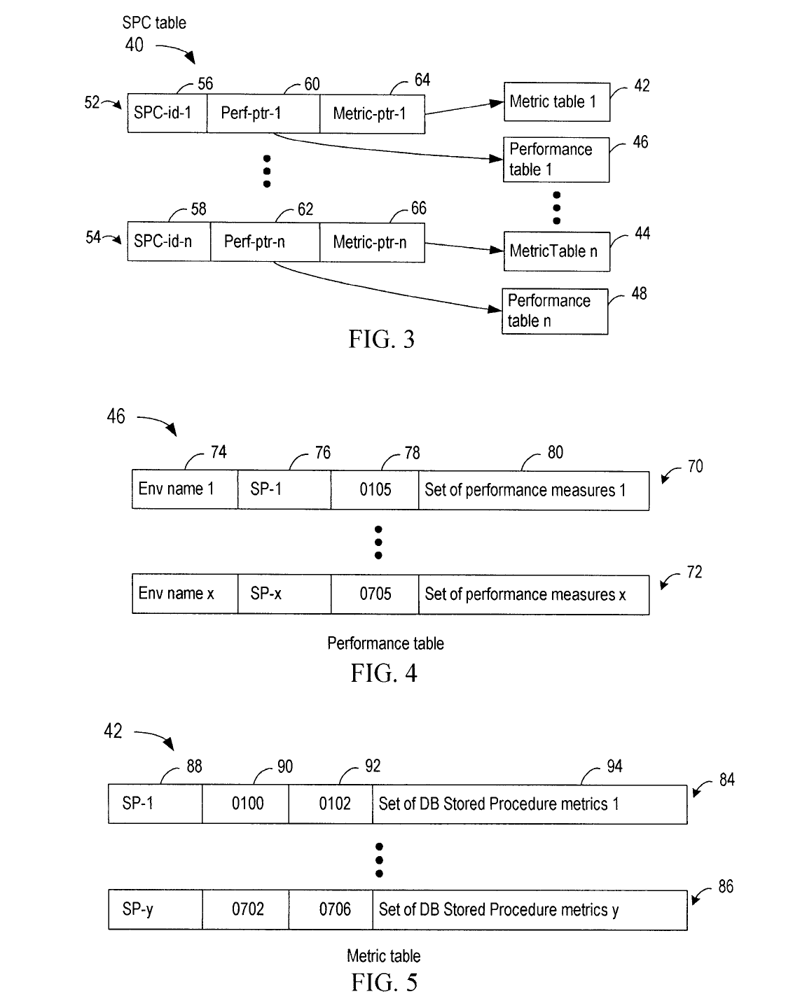

FIG. 3 depicts a diagram of an embodiment of a stored procedure component (SPC) table 40 and associated metric tables 42 and 44 and component tables 46 and 48. The SPC table 40 stores one or more SPC entries 52 and 54. Each SPC identifier 56 and 58 is associated with a performance table 46 and 48 and a metric table 42 and 44, respectively. The SPC entry 52 and 54, comprises an SPC identifier 56 and 58, an performance table pointer 60 and 62, and a metric table pointer 64 and 66. The performance table pointer 60 and 62 points to, that is, references, a performance table 46 and 48, respectively. In some embodiments, the performance table pointer 60 and 62 contains the memory address of the beginning of the performance table 46 and 48, respectively. The metric table pointer 64 and 66 references a metric table 42 and 44, respectively. In some embodiments, the metric table pointer 64 and 66 contains the memory address of the beginning of the metric table 42 and 44, respectively. In FIG. 3, SPC entry 52 contains a stored procedure address space identifier called SPC-id-1 with a performance table pointer called Perf-ptr-1 to performance table 1 46, and a metric table pointer called Metric-ptr-1 to metric table 1 42. In some embodiments, the SPC identifier is a name of the stored procedure address space. In other embodiments, the SPC identifier is a process identifier (ID).

FIG. 4 depicts a diagram of an embodiment of a performance table 46 of FIG. 3. Each entry 70 and 72 of the performance table 46 comprises an environment identifier 74, a stored procedure identifier 76, a sample time 78, and a set of one or more performance measures 80. In this example, the performance table 46 has “x” entries. The environment identifier 74 is the name of the machine, that is, computer system, on which the stored procedure which is associated with the stored procedure identifier 76, is being executed. In various embodiments, the stored procedure identifier 76 is the stored procedure name, such as the name of a script file; and in embodiments in which the stored procedure is a computer program, the stored procedure identifier 76 is the name of the computer program. The set of performance measures 80 comprises one or more performance measures which are associated with the performance of the component which is executing the stored procedure. The sample time is a timestamp indicating a time at which the performance measures associated with the stored procedure component are collected. In various embodiments, the sample time is the system time. For example, the set of performance measures 80 comprises the CPU time consumed by, and memory usage of the stored procedure executing on the component. In some embodiments, the set of performance measures is omitted.

For example, in row 70, the environment identifier 74 is “Env Name 1”. The stored procedure identifier 76 is a stored procedure name, “SP-1”. The exemplary sample time 78 is “0105”. In this example, the sample time has a format of “ssmm”, where “ss” represents a second and “mm” represents a millisecond. In other embodiments, other timestamps may be used. The row 70 also has a “Set of performance measures 1” 80.

FIG. 5 depicts a diagram of an embodiment of a metric table 42 of FIG. 3. The metric table 42 comprises metric table entries 84 and 86. Each metric table entry 84 and 86 comprises a stored procedure identifier 88, a start time 90, an end time 92, and a set database (DB) stored procedure metrics 94. The illustrative metric table 42 has “y” rows 84 and 86.

The start time 90 is a timestamp indicating a time at which the stored procedure started execution on a stored procedure component. The end time 92 is a timestamp indicating a time at which the stored procedure ended execution on the stored procedure component. The start and end times are typically timestamps representing the system time at which the stored procedure started and ended execution, respectively.

The set of database stored procedure metrics 94 comprises one or more database performance metrics. Some metrics are provided by the database accounting system and other metrics are derived from data of the database accounting system. In various embodiments, a stored procedure response time metric is equal to the difference between the start and end time. In some embodiments, the set of database stored procedure metrics is omitted.

For example, in row 84 of metric table 42, the stored procedure identifier 88 is “SP-1”. The exemplary start time 90 is “0100” and the exemplary end time 92 is “0102”. The row 84 also has a set of database stored procedure metrics, “Set of DB Stored Procedure metrics 1” 94. The set of database stored procedure metrics comprise one or more metrics. In this example, the start and end times have the format of “ssmm”, where “ss” represents a second and “mm” represents a millisecond. In other embodiments, other timestamps may be used.

The SPC, performance and metric tables may be stored as in-memory arrays in local memory. In other embodiments, the SPC, performance and metric tables may be stored in persistent storage. Alternately, the SPC, performance and metric tables are database tables.

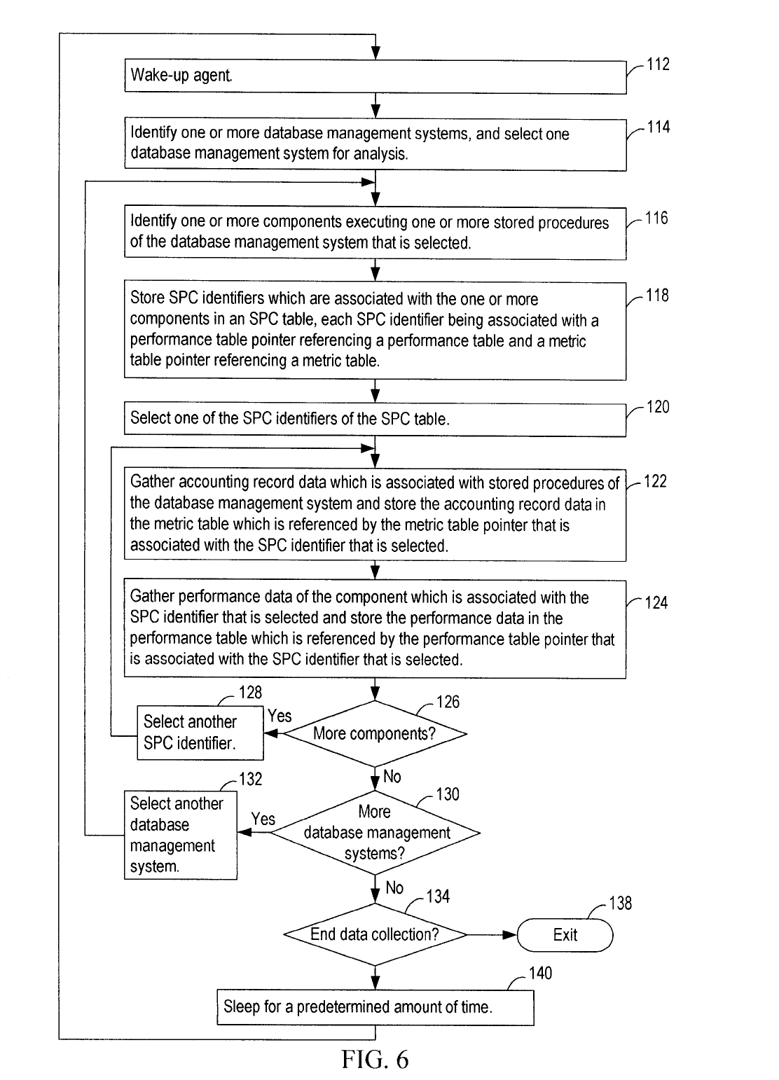

FIG. 6 depicts a flowchart of an embodiment of collecting accounting record and performance data. In various embodiments, the flowchart of FIG. 6 is performed by the agent. In step 112, the agent wakes-up, that is, is activated, at the start of sampling interval.

In step 114, the agent identifies one or more database management systems, and selects one database management system for analysis. In some embodiments, a particular database management system is specified when the agent is configured. For example, the agent receives a database subsystem ID as part of its configuration, and will only monitor that database subsystem or database management system. In other embodiments, multiple database management systems are monitored.

In step 116, the agent identifies one or more components executing one or more stored procedures of the database management system that is selected.

In step 118, the agent stores the SPC identifiers which are associated with the one or more components in an SPC table. Each SPC identifier is associated with a performance table pointer referencing a performance table and a metric table pointer referencing a metric table.

In step 120, the agent selects one of the SPC identifiers of the SPC table.

In step 122, the agent gathers accounting record data which is associated with stored procedures of the database management system and stores the accounting record data in the metric table which is referenced by the metric table pointer that is associated with the SPC identifier that is selected. The accounting record data comprises stored procedure identifiers, start and end times, and sets of DB stored procedure metrics. In some embodiments, the accounting record data is for the component that is associated with the SPC identifier. In other embodiments, the accounting record data if for multiple components, including the component that is associated with the SPC identifier that is selected. In some embodiments, the set of DB stored procedure metrics is omitted.

In step 124, the agent gathers performance data of the component which is associated with the SPC identifier that is selected and stores the performance data in the performance table which is referenced by the performance table pointer that is associated with the SPC identifier that is selected. The performance data comprises an environment identifier, stored procedure identifier, sample time, and a set of performance measures.

In step 126, the agent determines whether there are more components to analyze, that is, whether there are more stored procedure components to analyze. In response to determining that there are more components to analyze, in step 128, the agent selects another SPC identifier, and proceeds to step 122.

In response to step 126 determining that there are no more components to analyze, in step 130, the agent determines if there are more database management systems to analyze. In response to step 130 determining that there are more database management systems to analyze, in step 132, the agent selects another database management system, and proceeds to step 116.

In response to step 130 determining that there are no more database management systems to analyze, in step 134, the agent determines whether to end data collection. In some embodiments, the agent monitors an amount of time, the monitoring interval, for which it has been collecting data and in response to that amount of time reaching the predetermined monitoring interval, the agent ends data collection. In other embodiments, the agent is executed for a specified number of wake cycles, and in response to reaching a predetermined number of wake cycles, the agent ends data collection.

In response to step 134 determining that data collection is not ended, in step 136, the agent sleeps for a predetermined amount of time, that is, the sampling interval, and proceeds to step 112. In response to step 134 determining that data collection is ended, in step 138, the flowchart exits.

An embodiment of identifying the components executing stored procedures of step 116 will now be described in further detail. In various embodiments, in which a stored procedure component is a stored procedure address space, the agent identifies the stored procedure address spaces that are currently executing that belong to the identified database management system. The database management system has a database subsystem identifier (ID). The agent identifies the stored procedure address spaces that are currently executing that belong to the database subsystem based on the database subsystem ID. In the context of the z/OS operating system, the agent locates its own “Address Space Control Block” (ASCB) from a “Content Vector Table” (CVT) that is contained at a predetermined, fixed memory address. Using the database subsystem ID as a key, the agent follows the chain of ASCBs, and in some embodiments, “Optimizer User Control Blocks”, (OUCBs), and retrieves the names of the address spaces from the ASCBs and OUCBs.

A stored procedure address space is identified based on the address space name. A stored procedure address space name may have the following format: “xxxxWLMx”.

The first four characters “xxxx” represent a database identifier. In the z/OS operating system, a subsystem has a distinct subsystem identifier in accordance with predetermined naming conventions. For example, a database subsystem is named with a subsystem identifier such as “DB2G” or “DB02”. In this example, for the database identifier of “DB2G”, “DB2” indicates the DB2 database management system and the “G” represents a particular computer system. In other embodiments, other database identifiers may be used.

In the stored procedure address space name, the “WLM” identifies the address space as being managed by the Work Load Manager; and the last character “x” is an instance number of the work load managed space. An address space identifier in which the first three characters represent a specified database name and having the “WLM” characters is identified as a stored procedure address space by the agent.

In some embodiments, operating system application programming interfaces (APIs) are used to identify the stored procedure components and SPC identifiers. In other embodiments, in step 116, in an environment that uses processes rather than address spaces, the SPC identifiers are process identifiers (Ids), and an API is used to identify those processes which are executing stored procedures.

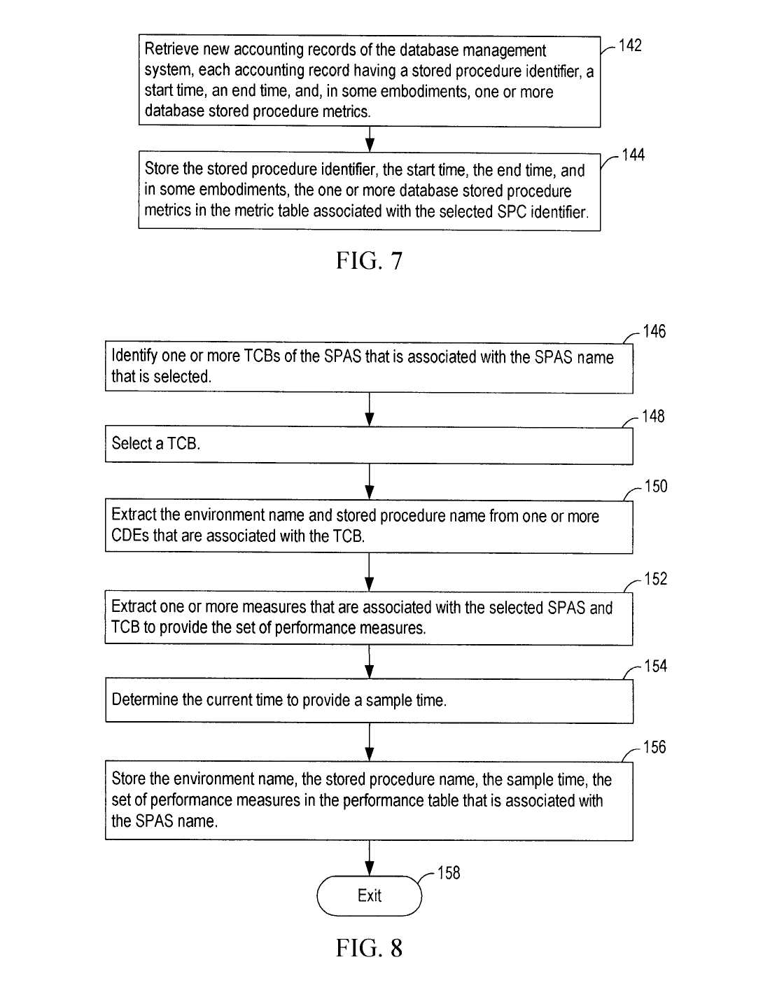

FIG. 7 depicts a flowchart of an embodiment of step 122 which gathers accounting record data which is associated with stored procedures of the database management system of FIG. 6.

In step 142, the agent retrieves new accounting records of the database management system. Each accounting record has a stored procedure identifier, a start time, an end time, and, in some embodiments, one or more database stored procedure metrics.

In step 144, the agent stores the stored procedure identifier, the start time, the end time, and, in some embodiments, the one or more database stored procedure metrics in the metric table. In some embodiments, the agent stores the data in the metric table sequenced by the start time and name of the stored procedure. That is, the data in the metric tables are stored in time sequence, based on the start time, and order in accordance of the name of the stored procedure.

FIG. 8 depicts a flowchart of an embodiment of step 124 of FIG. 6, which gathers performance data, in an environment in which the stored procedure components are stored procedure address spaces. The flowchart of FIG. 8 will be described with respect to a z/OS operating system environment having stored procedure address spaces and task control blocks.

In step 146, the agent identifies one or more TCBs of the SPAS that is associated with SPAS name that is selected. In some embodiments, an address space may contain one or more TCBs that are not associated with the processing of the stored procedures; these TCBs have well-known names and are excluded in step 146.

In step 148, the agent selects a TCB.

In step 150, the agent extracts the environment name and stored procedure name from one or more Content Directory Entry (CDE) control blocks that are associated with the TCB. In various embodiments, a SPAS is associated with an ASCB which points to a chain of Task Control Blocks that are responsible for executing the stored procedure. Each address space can have one or more TCBs because each address space can execute multiple stored procedures concurrently. In some embodiments, an address space can have a predetermined maximum number of TCBs. One TCB executes one program at a time. One or more CDE control blocks may be associated with the TCB. If there is a plurality of CDE control blocks, and because the last program called is the program that is active, the CDE control block of interest is the last one, and the other CDE control blocks are waiting for the last program to complete execution. The last CDE control block contains the name of the stored procedure that the TCB is currently executing and the environment name.

In step 152, the agent extracts one or more measures that are associated with the selected SPAS and TCB to provide the set of performance measures. These measures are associated with the stored procedure which is being executed and whose name is contained in the last CDE control block. Examples of measures comprise the CPU time consumed and the amount of memory used.

In step 154, the agent determines the current time to provide a sample time. The current time is typically the system time.

In step 156, the agent stores the environment name, the stored procedure name, the sample time and the set of performance measures in the performance table that is associated with the SPC identifier, in this embodiment, the SPAS name. In step 158, the flowchart exits.

In another embodiment, in a distributed database environment, step 116 of FIG. 6 uses an application programming interface (API) to identify the components which execute stored procedures at various databases. In some embodiments, a primary agent queries subsidiary agents at the various databases to identify the components which execute stored procedures. In other embodiments, the information to identify the components which execute stored procedures at the various databases is available to the primary agent using APIs, and subsidiary agents are not used. In step 124, in some embodiments, the primary agent queries subsidiary agents to collect the environment identifiers, stored procedure identifiers, sample times, and measures that are associated with the SPC identifiers. In other embodiments, the environment identifiers, stored procedure identifiers, sample times, and measures that are associated with the SPC identifiers is available to the primary agent using APIs and subsidiary agents are not used. In various embodiments, in step 122, the agent uses an API to gather the accounting record data from various databases.

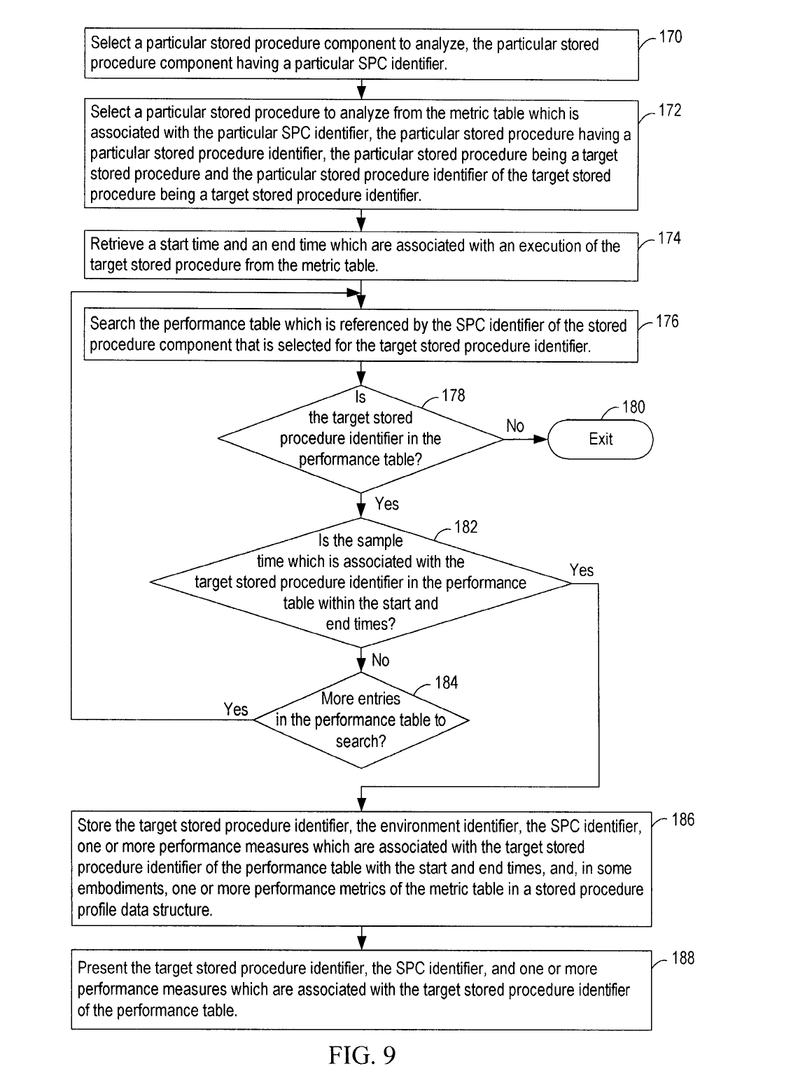

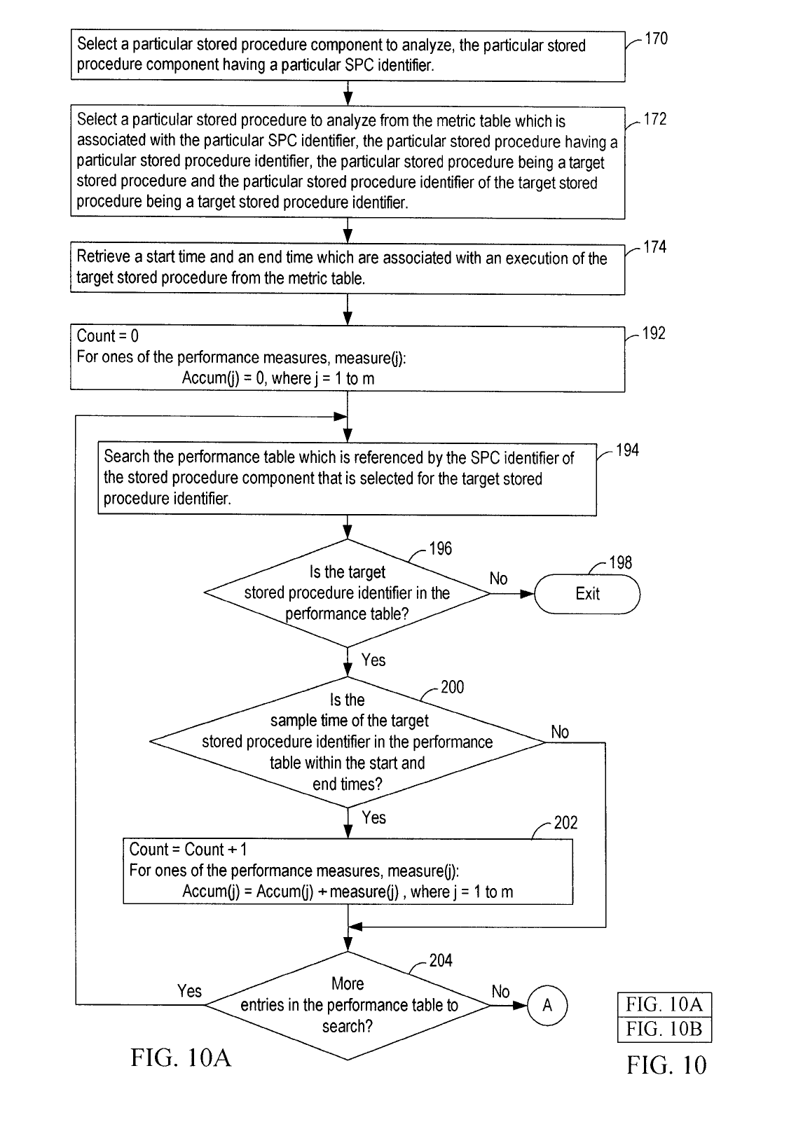

FIG. 9 depicts a flowchart of an embodiment of the steps which correlate and present accounting record and performance data of FIG. 1. The agent correlates the data from the accounting records with the performance data of the components on which stored procedures are executed. Steps 170-186 of FIG. 9 correspond to step 30 of FIG. 1; and step 188 of FIG. 9 corresponds to step 32 of FIG. 1.

In step 170, the agent selects a particular stored procedure component to analyze. The stored procedure component has a SPC identifier. In an alternate embodiment, a user selects the particular stored procedure component and provides the selection to the agent.

In step 172, the agent selects a particular stored procedure to analyze from the metric table which is associated with the particular SPC identifier. The stored procedure has a particular stored procedure identifier. The particular stored procedure is a target stored procedure and the particular stored procedure identifier of the target stored procedure is a target stored procedure identifier. In an alternate embodiment, a user selects the particular stored procedure and provides the selection to the agent.

In step 174, the agent retrieves a start time and an end time which are associated with an execution of the target stored procedure from the metric table.

In step 176, the agent searches the performance table which is referenced by the SPC identifier of the stored procedure component that is selected for the target stored procedure identifier.

In step 178, the agent determines whether the target stored procedure identifier is in the performance table. If not, in step 180, the flowchart exits.

In response to, in step 178, the agent determining that the target stored procedure identifier is in the performance table, in step 182, the agent determines whether the sample time which is associated with the target stored procedure identifier in the performance table is within the start and end times. If not, in step 184, the agent determines whether there are more entries in the performance table to search. If so, step 184 proceeds to step 176.

In response to, in step 184, the agent determining that the sample time which is associated with the target stored procedure identifier in the performance table is within the start and end times, in step 186, the agent stores the target stored procedure identifier, the environment identifier, the SPC identifier, one or more performance measures which are associated with the target stored procedure identifier of the performance table with the start and end times, and, in some embodiments, one or more performance metrics of the metric table in a stored procedure profile data structure.

Step 188 corresponds to step 32 of FIG. 1. In step 188, the agent presents the target stored procedure identifier, the SPC identifier, and one or more performance measures which are associated with the target stored procedure identifier of the performance table. In some embodiments, the environment identifier is also presented. In various embodiments, the start and end times, and, in some embodiments, one or more performance metrics of the metric table are also presented.

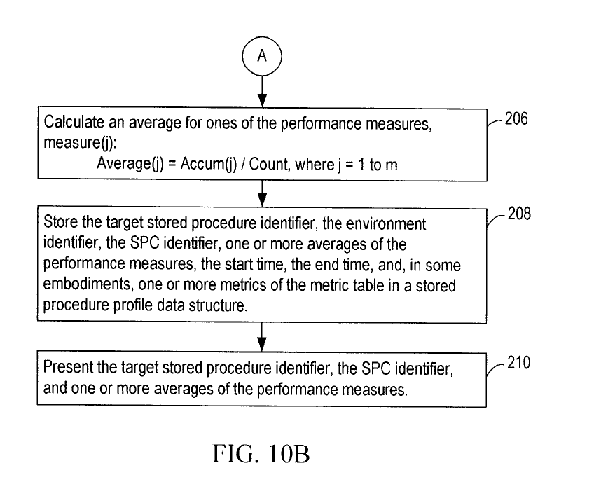

FIG. 10 comprises FIGS. 10A and 10B which collectively depict a flowchart of another embodiment of the steps which correlate and present accounting record and performance data of FIG. 1. In the embodiment of FIG. 10, the agent computes an average of the performance data for multiple samples of the performance data that occur within the start and end time of an execution of a stored procedure. Steps 170-174 and 192-208 correspond to step 30 of FIG. 1, and step 210 corresponds to step 32 of FIG. 1. Steps 170-174 are the same as in FIG. 9 and will not be further described.

In step 192, the agent initializes a “Count” equal to zero, and accumulators “Accum(j)” for each of the m performance measures equal to zero. In step 194, the agent searches the performance table which is referenced by the SPC identifier of the stored procedure component that is selected for the target stored procedure identifier.

In step 196, the agent determines whether the target stored procedure identifier is in the performance table. If not, in step 198, the flowchart exits.

In response to, in step 196, the agent determining that the target stored procedure identifier is in the performance table, in step 200, the agent determines whether the sample time which is associated with the target stored procedure identifier in the performance table is within the start and end times. If so, in step 202, the agent increments the “Count” by one, and for ones of the performance measures, measure(j), the performance measures are accumulated as follows:

Accum(j)=Accum(j)+measure(j), where j=1 to m

In step 204, the agent determines whether there are more entries in the performance table to search. If so, step 204 proceeds to step 194.

In response to, in step 198, the agent determining that the sample time of the target stored procedure identifier in the performance table is within the start and end times, step 198 proceeds to step 204.

In response to, in step 204, the agent determining that there are no more entries in the performance table to search, step 204 proceeds via Continuator A to step 206 of FIG. 10B.

In step 206, the agent calculates an average for ones of the performance measures, measures), as follows:

Average(j)=Accum(j)/Count, where j=1 to m

In step 208, the agent stores the target stored procedure identifier, the environment identifier, the SPC identifier, one or more averages of the performance measures, the start time, the end time, and, in some embodiments, one or more metrics of the metric table in a stored procedure profile data structure.

In step 210, the agent presents the target stored procedure identifier, the environment identifier, the SPC identifier, and one or more averages of the performance measures. In some embodiments, the environment identifier is also presented. In various embodiments, the start and end times, and, in some embodiments, one or more performance metrics of the metric table are also presented

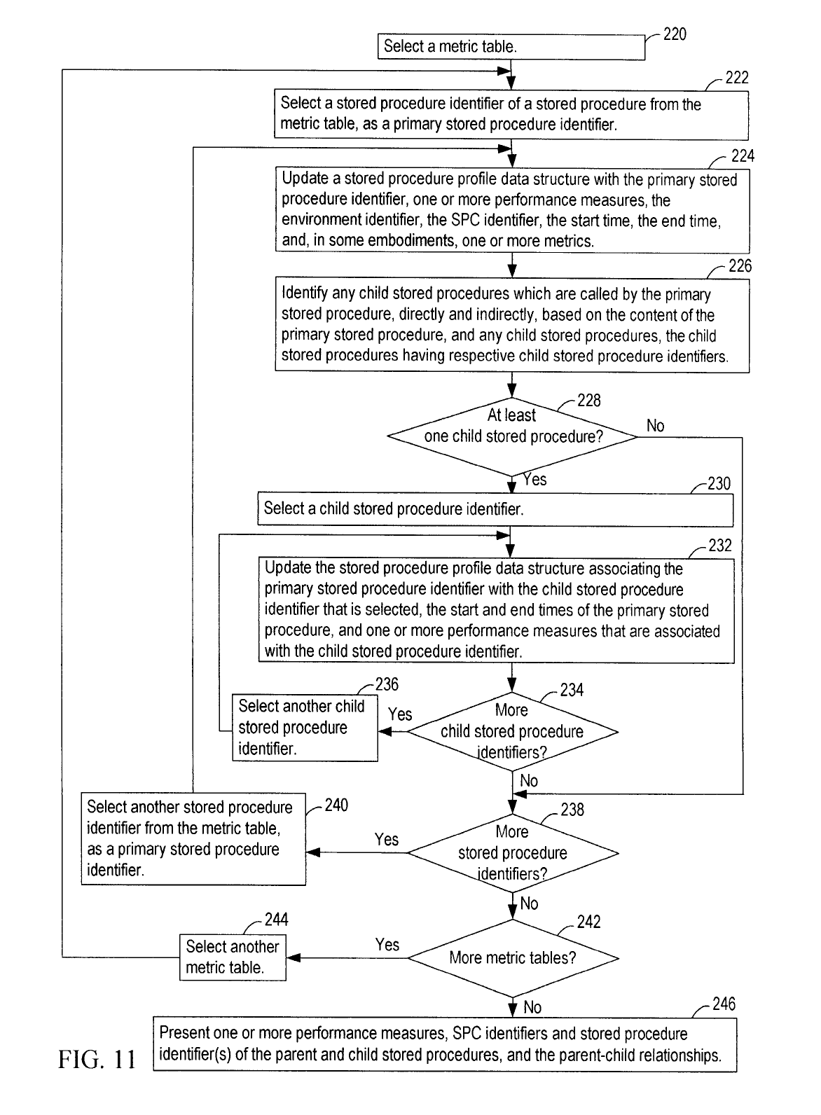

FIG. 11 depicts a flowchart of an embodiment of the steps which correlate and present accounting record and performance data of FIG. 2. In various embodiments, accounting record and performance data are correlated based on stored procedure identifiers, sample times, the content of the stored procedures and the start and end times from the stored procedure accounting records. In this way, the sequence of execution of stored procedures which are nested can be identified, and the component-based performance measures of those stored procedures can be determined. Steps 220-244 of FIG. 11 correspond to step 36 of FIG. 2; and step 246 of FIG. 11 corresponds to step 38 of FIG. 2.

In step 220, a metric table is selected. In some embodiments, the agent selects a metric table, for example, the metric table which is associated with the first SPC identifier of the SPC table. Alternately, the agent may use other criteria to select a metric table. In other embodiments, a user selects a stored procedure component and the agent selects the metric table that is associated with the stored procedure component.

In step 222, a stored procedure identifier of a stored procedure is selected from the metric table as a primary stored procedure identifier. The stored procedure that is selected is a primary stored procedure. In some embodiments, the agent selects the stored procedure identifier, such as the first stored procedure identifier. In other embodiments, the user selects the stored procedure identifier.

In step 224, the agent updates a stored procedure profile data structure with the primary stored procedure identifier, one or more performance measures, the environment identifier, the SPC identifier, the start time, the end time, and, in some embodiments, one or more metrics.

In step 226, the agent identifies any child stored procedures which are called by the primary stored procedure, directly and indirectly, based on the content of the primary stored procedure, and any child stored procedures. The child stored procedures have respective child stored procedure identifiers. Therefore, parent-child relationships among the stored procedures are identified.

In step 228, in response to identifying at least one child stored procedure, in step 230, the agent selects a child stored procedure identifier.

In step 232, the agent updates the stored procedure profile data structure associating the primary stored procedure identifier with the child stored procedure identifier that is selected, the start and end times of the primary stored procedure, and one or more performance measures that are associated with the child stored procedure identifier.

In step 234, the agent determines whether there are more child stored procedure identifiers, that is, whether there are more child stored procedures which are called, directly or indirectly, by the primary stored procedures. If so, in step 236, the agent selects another child stored procedure identifier, and proceeds to step 232.

In response to the agent determining in step 234 that there are no more identified child stored procedure identifiers, in step 238, the agent determines whether there are more stored procedure identifiers in the metric table to analyze. If so, in step 240, the agent selects another stored procedure identifier from the metric table, as a primary stored procedure identifier and proceeds to step 224.

In response to the agent determining in step 238, that there are no more stored procedure identifiers in the metric table to analyze, in step 242, the agent determines whether there are more metric tables to analyze. If so, in step 244, the agent selects another metric table and proceeds to step 222.

In response to step 228 determining that there is not at least one child stored procedure, step 288 proceeds to step 238.

In response to the agent determining in step 242 that there are no more metric tables, in step 246, the agent presents one or more performance measures, SPC identifiers and stored procedure identifier(s) of the parent and child stored procedures, and the parent-child relationships.

In an alternate embodiment, the flowchart of FIG. 11 is performed for a single stored procedure and steps 238, 240, 242 and 244 are omitted.

The identification of any child stored procedures of the primary stored procedure of step 226 of FIG. 11 will now be explained in further detail. In step 226, the agent identifies one or more child stored procedures which are called by the primary stored procedure that is associated with the primary stored procedure identifier based on the content of the primary stored procedure. The content of the stored procedure comprises the code or instructions of the stored procedure. In various embodiments using DB2, using SQL, the agent retrieves information about the stored procedure from the SYSIBM.SYSROUTINES and SYSIBM.SYSPARMS database files. The stored procedure's readable content is stored in SYSIBM.SYSROUTINES. SYSIBM.SYSROUTINES also contains the stored procedure name, the environmental language, and in some embodiments, and other information. Examples of the environmental language in SYSIBM.SYSROUTINES comprise SQL, Java and “C”. SYSIBM.SYSPARMS contains data definitions.

In various embodiments, for stored procedures that do not define the execution of a program, the stored procedure identifier is the stored procedure name, and the stored procedure name becomes a correlator. For stored procedures that define the execution of a program, the stored procedure identifier is the name of the program, and the program name becomes the correlator. For example, for a stored procedure that defines a “C” program, the name of the “C” program is used because that name will be contained in the CDE control block. If the stored procedure comprises one or more SQL statements in a textual format, the name of that stored procedure is used because that name will be contained in the CDE control block.

The agent examines the content of the stored procedure to determine if the stored procedure invokes or calls any other stored procedures. Typically, the agent examines the content of the stored procedures that are written in SQL. In various embodiments, if a stored procedure is written in a language such as “C”, which is compiled to produce executable object code, that stored procedure is not analyzed for child stored procedures. The calling stored procedure is a parent stored procedure. A stored procedure which is called, is a child stored procedure. A child stored procedure may be at a different database, which may be on a different computer system. The content of any child stored procedures is also examined to identify additional child stored procedures until no more child stored procedures are identified. For example, another data structure, referred to as a stored procedure nesting table, is maintained in memory based on the selected, primary stored procedure name which associates the primary stored procedure name with the name of any child stored procedures. For example, a stored procedure named SP 1 calls another stored procedure called SP2, and the stored procedure nesting table may be as shown in Table 1 below:

TABLE 1
Exemplary Stored Procedure Nesting Table

| Parent Stored Procedure Name | Child Stored Procedure Name |
|---|---|
| SP1 | SP2 |

In various embodiments of step 180, the agent selects the child stored procedure identifier from the stored procedure nesting table.

In other embodiments, other types of data structures may be used to describe the parent-child relationships of the primary stored procedure and any child stored procedures.

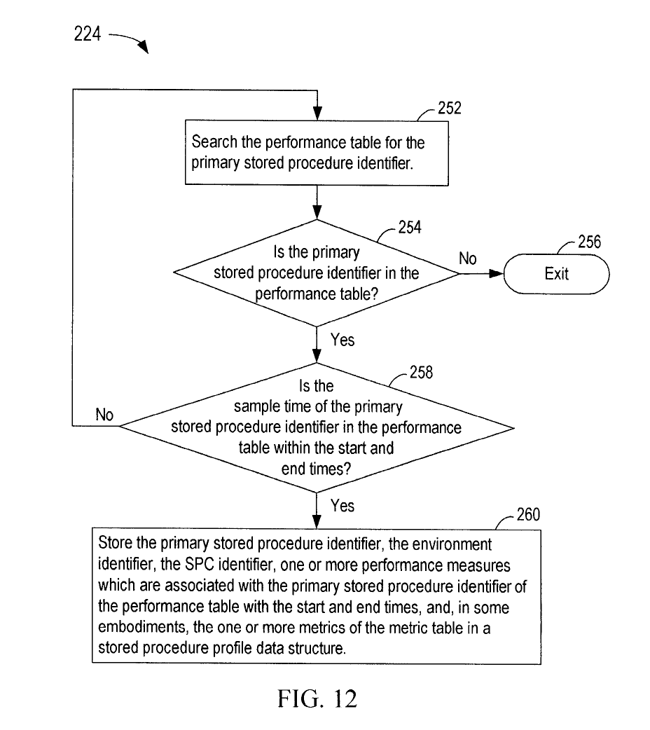

FIG. 12 depicts a flowchart of an embodiment of step 224 which updates the stored procedure profile data structure with performance measures and, in some embodiments, metrics that are associated with a primary stored procedure identifier of FIG. 11. The flowchart of FIG. 12 receives the primary stored procedure identifier, the start time and the end time, the SPC identifier associated with the metric table, and the performance table pointer which references the performance table that is associated with metric table. The start time and end time are retrieved from the metric table based on the primary stored procedure identifier.

In step 252, the agent searches the performance table for the primary stored procedure identifier. The performance table which is searched is that performance table which is associated with the metric table which is selected in step 220 of FIG. 11.

In step 254, the agent determines whether the primary stored procedure identifier is in the performance table. If not, in step 256, the agent exits. If in step 254, the agent determines that the primary stored procedure identifier is in the performance table, in step 258, the agent determines whether the sample time of the primary stored procedure identifier in the performance table is within the start and end times. If not, the agent proceeds to step 252.

In response to, in step 258, the agent determining that the sample time of the primary stored procedure identifier in the performance table is within the start and end times, in step 260, the agent stores the primary stored procedure identifier, the environment identifier, the SPC identifier, one or more performance measures which are associated with the primary stored procedure identifier of the performance table with the start and end times, and the one or more metrics of the metric table in a stored procedure profile data structure.

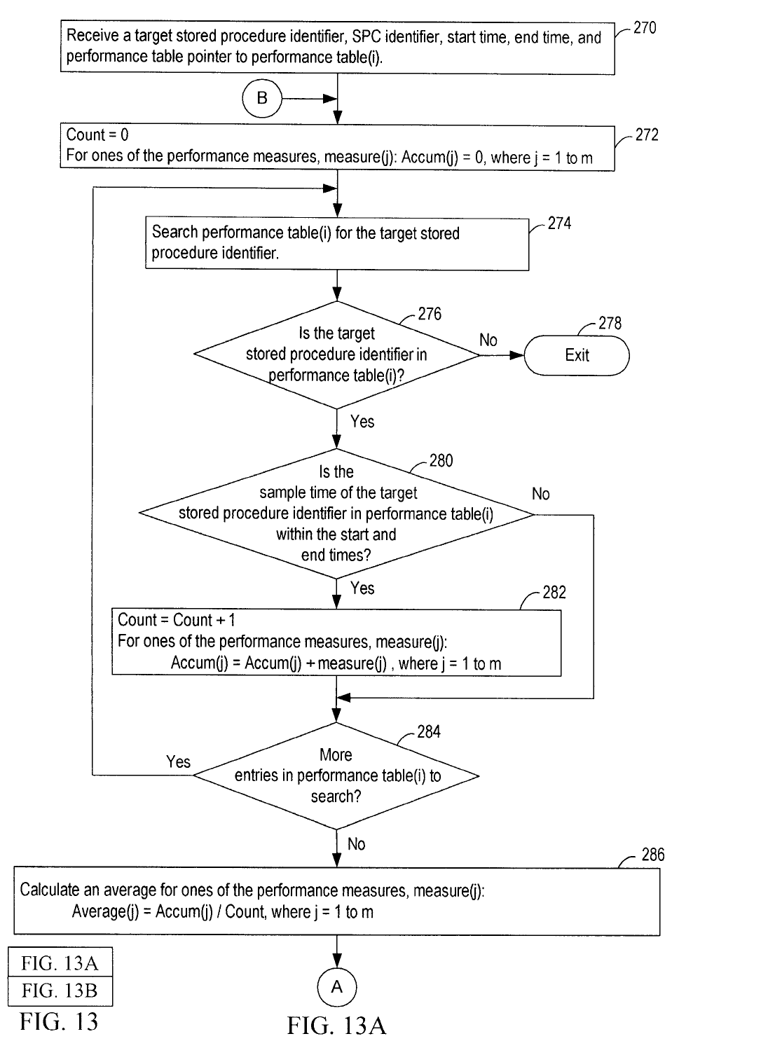

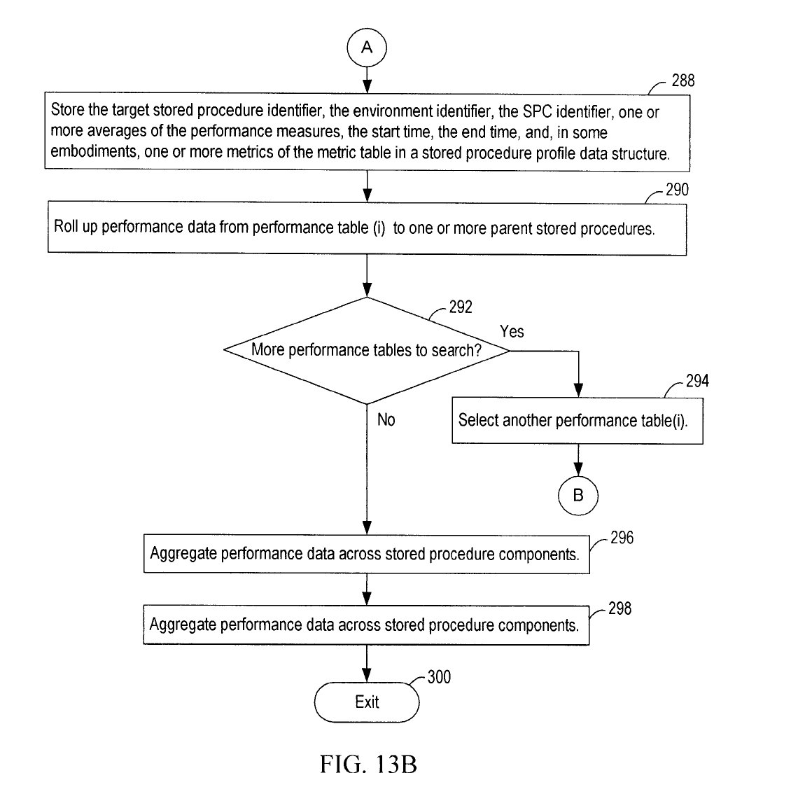

FIG. 13 comprises FIGS. 13A and 13B which collectively depict a flowchart of an embodiment of step 232 of FIG. 11 which updates the stored procedure profile data structure associating the primary stored procedure with the child stored procedure based on the stored procedure identifiers, start and end times of the primary stored procedure and the sample time. The primary stored procedure is referred to as the parent stored procedure. In other embodiments with multiple levels of child stored procedures, a child stored procedure may also be designated as a parent stored procedure of another child stored procedure.

In FIG. 13, the target stored procedure identifier is the child stored procedure identifier. In various embodiments, the start time and end time are the start time and end time of the parent stored procedure of the child stored procedure. The start time and end time are used to determine whether the child stored procedure is executed concurrently with the parent stored procedure.

In step 270, the agent receives a target stored procedure identifier, SPC identifier, start time, end time, and performance table pointer to performance table(i). In some embodiments, either the SPC identifier or the performance table pointer is provided. If the SPC identifier is provided, the agent retrieves the performance table pointer from the SPC table. If the performance table pointer is provided, the SPC identifier can be retrieved from the SPC table based on the performance table pointer. In various embodiments, the start and end times are those of the parent stored procedure of the target stored procedure.

In step 272, the agent sets the “Count” equal to zero, and for ones of the performances measures (measure(j)), an accumulator “Accum(j)” is set equal to zero where j is equal 1 to m.

In step 274, the agent searches performance table(i) for the target stored procedure identifier. In step 276, the agent determines whether the target stored procedure identifier is in performance table(i). If not, in step 278, the flowchart exits.

In response to, in step 276, the agent determining that the target stored procedure identifier is in performance table(i), in step 280, the agent determines whether the sample time of the target stored procedure identifier in performance table(i) is within the start and end times. If so, in step 282, the “Count” is incremented by one, and for ones of the performance measures (measures)), the Accumulators are updated as follows:

Accum(j)=Accum(j)+measure(j), where j=1 to m

In step 284, the agent determines whether there are more entries in performance table(i) to search. If so, step 284 proceeds to step 274.

In response to, in step 280, the agent determining that the sample time of the target stored procedure identifier in performance table(i) is not within the start and end times, step 280 proceeds to step 284.

In response to, in step 284, the agent determining that there are no more entries in performance table(i) to search, in step 286, the agent calculates an average for ones of the performance measures (measure(j)), as follows:

Average(j)=Accum(j)/Count, where j=1 to m

In some embodiments, in which Count is equal to one, the Average represents the value of a single performance measure. Step 286 proceeds via Continuator A to step 288 of FIG. 13B. In some embodiments, if the Count is equal to zero, steps 286, 288 and 290 are not performed.

In step 288 of FIG. 13B, the agent stores the target stored procedure identifier, the environment identifier, the SPC identifier, one or more averages of the performance measures, the start time, the end time, and, in some embodiments, one or more metrics of the metric table in a stored procedure profile data structure.

In step 290, the agent rolls up performance data from performance table (i) to one or more parent stored procedures. The agent rolls-up one or more measures and, in some embodiments, one or more metrics that are associated with the selected child stored procedure identifier to the parent stored procedure(s), and stores the rolled up measures, and in some embodiments, metrics. For example, the agent performs a roll-up based on including any counts, minimum (min), maximum (max) and averages that are associated with the child stored procedure into the counts, min, max and averages that are associated with the parent stored procedure. In some embodiments, the roll-ups are segmented by components, such as stored procedure address spaces, in other embodiments, a roll-up is one all encompassing value for the measure, and in yet other embodiments, the roll-ups comprise both segmented roll-ups and all encompassing roll-ups for the measure. In various embodiments, if the stored procedures are nested, the roll-ups are segmented by the performance of the primary stored procedure followed by the performance of each nested Stored Procedure. In another example, if stored procedure SP1 calls stored procedure SP2, and stored procedure SP2 calls stored procedure SP3, and there is a measure called counter associated with each stored procedure, the value of counter of SP3 is added to the value of counter of SP2, and the value of counter of SP3 is added to the value of counter of SP1. In other embodiments, step 290 is omitted.

In step 292, the agent determines whether there are more performance tables to search. If not, in step 294, the agent selects another performance table (i) and proceeds via Continuator B to step 272 of FIG. 13A.

In response to, in step 292, the agent determining that there are no more performance tables to search, in step 296, the agent aggregates performance data across stored procedure components. In step 298, the agent stores the aggregated performance data in the stored procedure profile data structure. In some embodiments, steps 296 and 298 are omitted. In step 300, the flowchart exits.

In some embodiments, the stored procedures are executed across different physical computer systems. Each computer system has an agent, and the SPC, metric and performance tables of each computer system are accessible over a network. The agents have an API to query the information in their associated SPC, metric and performance tables. In addition, the computer systems have a substantially synchronized clock and correct time zone settings. In other systems, the clocks are observed and a delta time is computed which contains the time difference between all clocks. That delta time is used to virtually synchronize the clocks without having to actually set the clocks.

In various embodiments, the same stored procedure can be executed concurrently by a plurality of requestors. In these embodiments, the performance measures associated with the stored procedure are averaged.

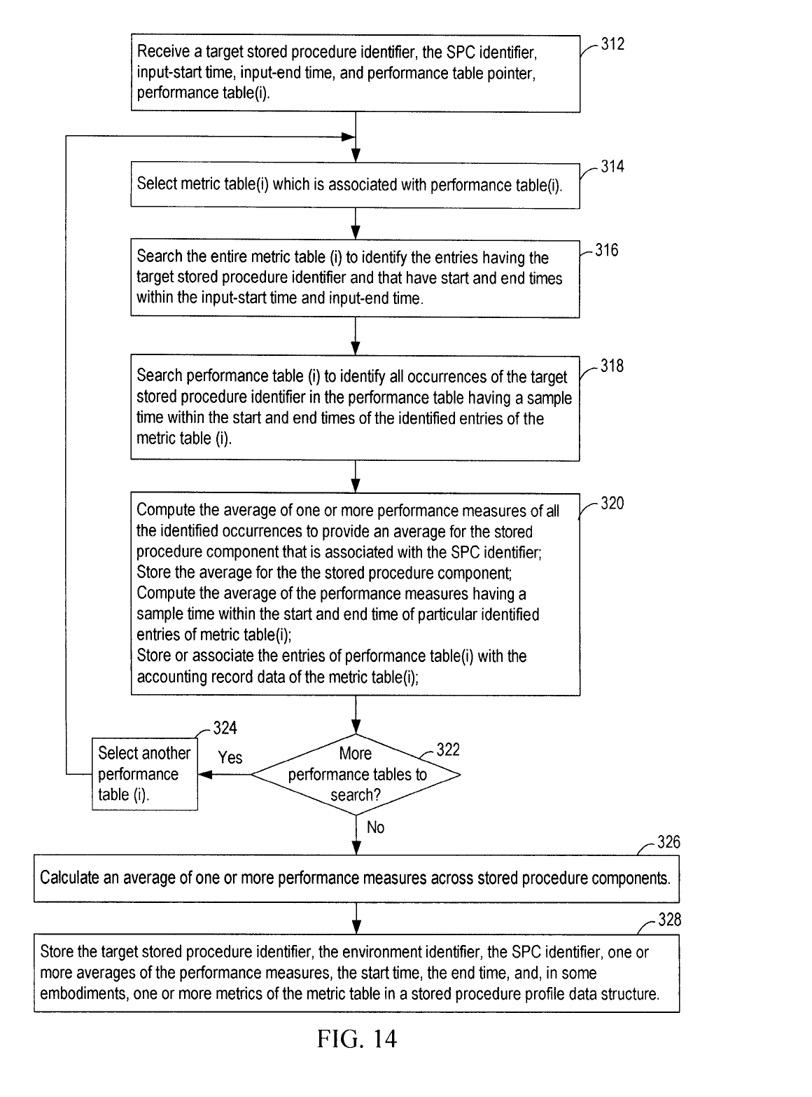

FIG. 14 depicts a flowchart of another embodiment of the step that correlates accounting record and performance data of a stored procedure of FIG. 2. In the flowchart of FIG. 14, a search is performed in the metric table to identify a start and end time of the child stored procedure which is within the start and end time of the parent stored procedure prior to searching the corresponding performance table for the child stored procedure identifier. In this way, some entries in the performance table may be excluded by using the narrower window of time of the child stored procedure data from the metric table.

In step 312, the agent receives a target stored procedure identifier, the SPC identifier, input-start time, input-end time, and performance table pointer, performance table(i). The input-start time and input-end time are the start and end times of the parent stored procedure of the target stored procedure.

In step 314, the agent selects metric table(i) which is associated with performance table(i).

In step 316, the agent searches the entire metric table (i) to identify the entries having the target stored procedure identifier and that have start and end times within the input-start time and input-end time.

In step 318, the agent searches performance table (i) to identify all occurrences of the target stored procedure identifier in the performance table having a sample time within the start and end times of the identified entries of the metric table (i) of step 316.

In step 320, the agent computes the average of one or more performance measures of all the identified occurrences of step 318 to provide an average for the stored procedure component that is associated with the SPC identifier; stores the average for the stored procedure component; computes the average of the performance measures having a sample time within the start and end time of particular identified entries of metric table(i); and stores or associates the entries of performance table(i) with the accounting record data of the metric table(i).

In step 322, the agent determines if there are more performance tables to search. If so, in step 324, the agent selects another performance table (i) and proceeds to step 314.

In response to, in step 322, the agent determining that there are no more performance tables to search, in step 326, the agent calculates an average of one or more performance measures across stored procedure components.

In step 328, the agent stores the target stored procedure identifier, the environment identifier, the SPC identifier, one or more averages of the performance measures, the start time, the end time, and, in some embodiments, one or more metrics of the metric table in a stored procedure profile data structure.

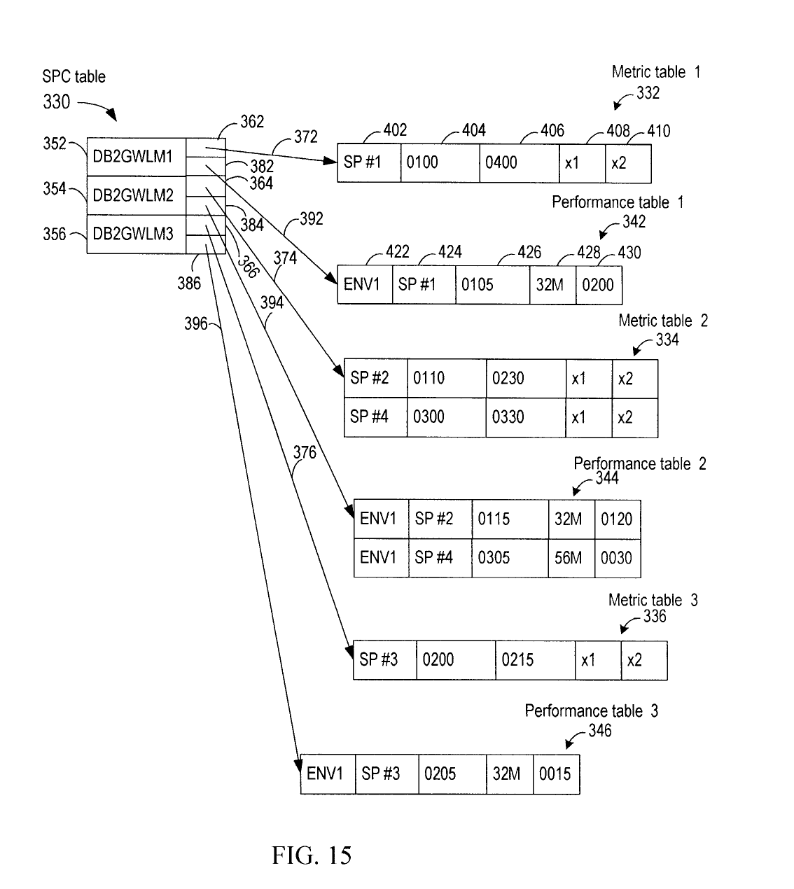

FIG. 15 depicts an illustrative SPC table 330, illustrative metric tables 332, 334 and 336 and illustrative tables 342, 344 and 346. The SPC table 440 has three entries 352, 354 and 356. Each entry 352, 354 and 356 has an SPC identifier, in this example, SPAS names, DB2GWLM1, DB2GWLM2, and DB2GWLM3, respectively. Each entry 352, 354 and 356 has a metric table pointer 362, 364 and 366, as indicated by arrows 372, 374 and 376, to metric tables, 332, 334 and 336, respectively. Each entry 292, 294 and 296 has a performance table pointer 382, 384 and 386, as indicated by arrows 392, 394 and 396, to performance tables, 342, 344 and 346, respectively.

Metric table 1 332 contains a stored procedure name “SP #1” 402, start time “0100” 404, end time “0400” 406, and one or more metrics x1 408 and x2 410. Metric tables 334 and 336 also contain a stored procedure name, start time, end time, and metrics.

Performance table 1 342 contains an environment name “ENV1” 422, stored procedure name “SP #1” 424, sample time “0105” 426, a memory usage measure “32M” 428 and a CPU time consumption measure “0200” 430. Performance tables 344 and 346 also contain an environment name, stored procedure name, sample time, a memory usage measure and a CPU time consumption measure.

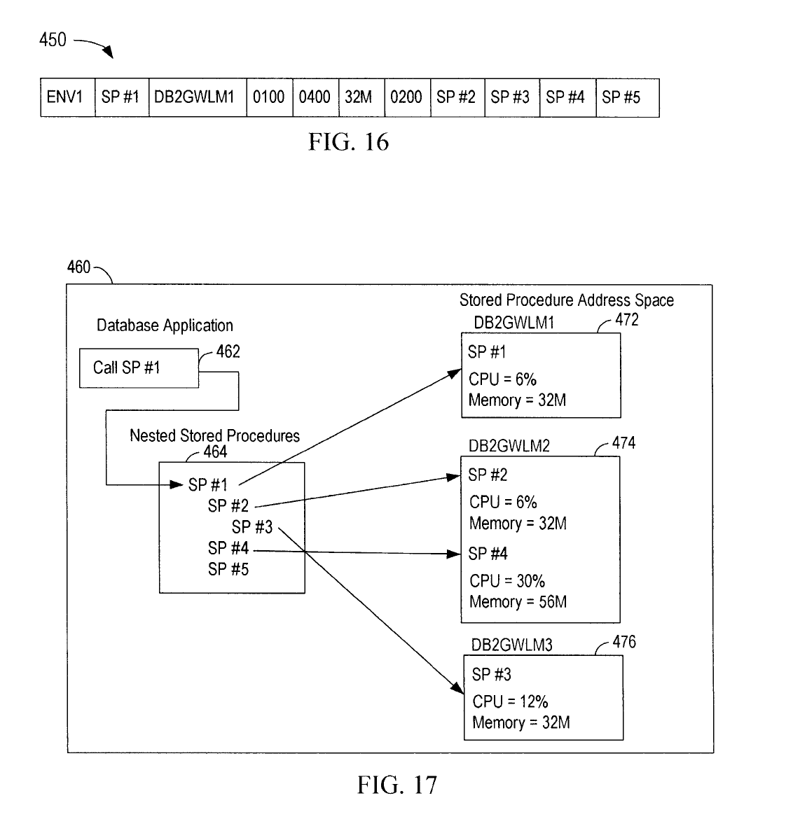

FIG. 16 depicts an illustrative stored procedure profile data structure 450 that is associated with the metric and performance tables of FIG. 15. Stored procedure SP #1 calls SP #2, SP#4 and SP#5. SP #2 calls SP #3. In the stored procedure profile data structure 450, the primary stored procedure “SP #1” is in environment “ENV1”, with a SPAS name of “DB2GWLM1”, with a start time of “0100” and end time of “0400”, memory usage measure of “32M” and CPU consumption of “0200”, and is associated with data, measures and metrics for “SP #2”, “SP #3”, “SP #4” and “SP #5”. The data and measures for “SP #2”, “SP #3”, “SP #4” and “SP #5” comprise the SPAS name, stored procedure name, start and end times, and one or more measures, and, in this example, are considered to be included in the blocks labeled “SP #2”, “SP #3”, “SP #4” and “SP #5”. The parent-child relationships among the stored procedures may be indicated in various ways, such as using a tree structure.

FIG. 17 depicts a block diagram of an exemplary graphical user interface 460 presenting the illustrative performance data of FIG. 15 which is correlated in accordance with the flowchart of FIG. 2. The performance data of FIG. 17 corresponds to the SPC, performance and metrics tables of FIG. 15. A database application 462 calls stored procedure SP #1. Block 464 illustrates the relationships of the stored procedures. As shown in block 464, stored procedures SP #2, #4 and #4 are nested within SP #1, and SP #3 is nested within SP #2 and therefore SP #1. As illustrated by block 472, SPAS “DB2GWLM1” contains performance data for SP #1. The CPU utilization of SP #1 is 6% and the memory usage for SP #1 is 32 Megabytes. As illustrated by block 474, SPAS “DB2GWLM2” contains performance data of SP #2 and SP #4. The CPU utilization of SP #2 is 6% and the memory usage of SP #2 is 32 Megabytes. The CPU utilization of SP #4 is 30% and the memory usage of SP #4 is 56 Megabytes. As illustrated by block 4716, SPAS “DB2GWLM3” contains performance data for SP #3. The CPU utilization of SP #3 is 12% and the memory usage for SP #3 is 32 Megabytes. In various embodiments, the data of FIG. 17 is stored as a correlation result in the stored procedure profile data structure.

Therefore, in various embodiments, a stored procedure's response time and performance can be measured as it dynamically executes wherever the operating system decides.

Various embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, various embodiments of the invention can take the form of a computer program product accessible from a computer usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disk (DVD).

FIG. 18 depicts an illustrative data processing system 480 which uses various embodiments of the present invention. The data processing system 480 suitable for storing and/or executing program code will include at least one processor 482 coupled directly or indirectly to memory elements 484 through a system bus 486. The memory elements 484 can include local memory employed during actual execution of the program code, bulk storage, and cache memories which provide temporary storage of at least some program code in order to reduce the number of times code must be retrieved from bulk storage during execution.

Input/output or I/O devices 488 (including but not limited to, for example, a keyboard 492, pointing device such as a mouse 494, a display 496, printer 498, etc.) can be coupled to the system bus 486 either directly or through intervening I/O controllers.

Network adapters, such as a network interface (NI) 500, may also be coupled to the system bus 486 to enable the data processing system to become coupled to other data processing systems or remote printers or storage devices through intervening private or public networks 502. Modems, cable modem and Ethernet cards are just a few of the currently available types of network adapters. The network adapter may be coupled to the network via a network transmission line, for example twisted pair, coaxial cable or fiber optic cable, or a wireless interface that uses a wireless transmission medium. In addition, the software in which various embodiments are implemented may be accessible through the transmission medium, for example, from a server over the network.

The memory elements 484 store an operating system 504, a database management system 506, a work load manager (WLM) 508, one or more components 510 comprising at least one stored procedure component, one or more stored procedures 512, an agent 514, an SPC table 516, one or more metric tables 518, one or more performance tables 520, a stored procedure nesting table 522, a stored procedure profile data structure 524 and in some embodiments, a correlation result 526.

The operating system 504 may be implemented by any conventional operating system such as z/OS, MVS, OS/390, AIX, UNIX, WINDOWS, LINUX, Solaris and HP-UX. Various embodiments of the present invention may also operate in a the Customer Information Control System (CICS) environment

The exemplary data processing system 480 illustrated in FIG. 18 is not intended to limit the present invention. Other alternative hardware environments may be used without departing from the scope of the present invention.

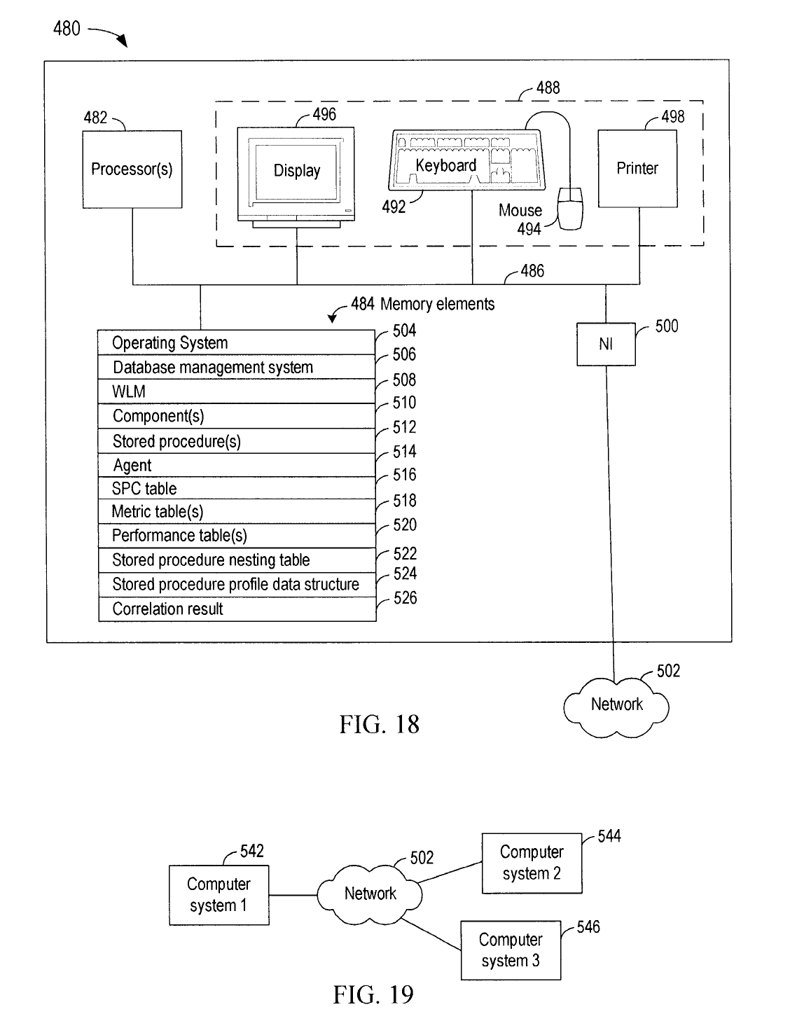

FIG. 19 depicts an exemplary distributed database environment comprising a first computer system (Computer System 1) 542 coupled to a second computer system (Computer System 2) 544 and a third computer system (Computer System 3) 546 via the network 502. In some embodiments, the first computer system 542 is the data processing system 480 of FIG. 18, and the second computer system 544 also comprises the hardware of data processing system 480. A primary agent at the first computer system can retrieve performance data from the SPC, performance and metric tables of the second computer system from a subsidiary agent at the second computer system and from another subsidiary agent at the third computer system. In some embodiments, only the primary agent maintains SPC, performance and metric tables, and the subsidiary agents provide requested data to the primary agent.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

### Trademarks

IBM®, DB2®, z/OS®, CICS®, MVS®, OS/390® and AIX® are registered trademarks of International Business Machines Corporation. UNIX® is a registered trademark of the Open Group in the United States and other countries. WINDOWS is a Registered trademark of Microsoft Corporation. LINUX® is a registered trademark of Linus Torvalds. Solaris® is a registered trademark of Sun Microsystems Inc. HP-UX® is a registered trademark of Hewlett-Packard Development Company, L.P.

What is claimed is:

1. A computer-implemented method comprising:
identifying one or more components on which one or more stored procedures are executed, said stored procedures having stored procedure identifiers, respectively;
gathering database data that is associated with at least one of said one or more stored procedures from a database management system, wherein said database data comprises at least one of said stored procedure identifiers, at least one execution start time and at least one execution end time;
gathering component-based data that is associated with said one or more components, said component-based data comprising at least one of said stored procedure identifiers and at least one sample time; and
correlating said database data and said component-based data based on a particular one of said stored procedure identifiers, said at least one execution start time, said at least one execution end time, and said at least one sample time that is associated with said particular one of said stored procedure identifiers.

2. The method of claim 1 wherein said component-based data also comprises one or more performance measures, and wherein said correlating determines that said database data and said component-based data are correlated based on said at least one sample time that is associated with said particular one of said stored procedure identifiers being within said at least one execution start time and said at least one execution end time that is associated with said particular one of said stored procedure identifiers.

3. The method of claim 2, further comprising:
identifying at least one child stored procedure of a particular one of said stored procedures that is associated with said particular one of said stored procedure identifiers, based on a content of said particular one of said stored procedures, said at least one child stored procedure having a child stored procedure identifier;
wherein said correlating is also based on said child stored procedure identifier, and a sample time that is associated with said child stored procedure identifier.

4. The method of claim 3, further comprising:
presenting said particular one of said stored procedure identifiers, said at least one child stored procedure identifier, said one or more performance measures that are associated with said particular one of said stored procedure identifiers, and one or more performance measures that are associated with said child stored procedure identifier.

5. The method of claim 1 wherein said components are stored procedure address spaces.

6. The method of claim 1 wherein at least one of said components is on a different computer system from other of said components.

7. The method of claim 3 further comprising:
rolling-up at least one of said performance measures that are associated with said child stored procedure identifier to said particular one of said stored procedure identifiers.

8. A computer program product comprising a computer usable medium having a computer readable program, wherein the computer readable program when executed on a computer causes the computer to:
identify one or more components on which one or more stored procedures are executed, said stored procedures having stored procedure identifiers, respectively;
gather database data that is associated with at least one of said one or more stored procedures from a database management system, wherein said database data comprises at least one of said stored procedure identifiers, at least one execution start time and at least one execution end time;
gather component-based data that is associated with said one or more components, said component-based data comprising at least one of said stored procedure identifiers and at least one sample time; and
correlate said database data and said component-based data based on a particular one of said stored procedure identifiers, said at least one execution start time, said at least one execution end time, and said at least one sample time that is associated with said particular one of said stored procedure identifiers.

9. The computer program product of claim 8 wherein said correlating determines that said database data and said component-based data are correlated based on said at least one sample time that is associated with said particular one of said stored procedure identifiers being within said at least one execution start time and said at least one execution end time that is associated with said particular one of said stored procedure identifiers.

10. The computer program product of claim 9 wherein the computer readable program when executed on the computer causes the computer to:
identify at least one child stored procedure of a particular one of said stored procedures that is associated with said particular one of said stored procedure identifiers, based on a content of said particular one of said stored procedures, said at least one child stored procedure having a child stored procedure identifier;
wherein said correlating is also based on said child stored procedure identifier, and a sample time that is associated with said child stored procedure identifier.

11. The computer program product of claim 10 wherein said component-based data also comprises one or more performance measures, and wherein the computer readable program when executed on the computer causes the computer to:
present said particular one of said stored procedure identifiers, said at least one child stored procedure identifier, said one or more performance measures that are associated with said particular one of said stored procedure identifiers, and one or more performance measures that are associated with said child stored procedure identifier.

12. The computer program product of claim 8 wherein said components are stored procedure address spaces.

13. The computer program product of claim 8 wherein at least one of said components is on a different computer system from other of said components.

14. The computer program product of claim 8 wherein said component-based data also comprises one or more performance measures.

15. The computer program product of claim 10 wherein the computer readable program when executed on the computer causes the computer to:
roll-up at least one of said performance measures that are associated with said child stored procedure identifier to said particular one of said one or more stored procedures.

16. A data processing system, comprising:
a processor; and
one or more memory elements comprising:
one or more components on which one or more stored procedures are executed, said stored procedures having stored procedure identifiers, respectively;
database data that is associated with at least one of said one or more stored procedures from a database management system, wherein said database data comprises at least one of said stored procedure identifiers, at least one execution start time and at least one execution end time;
component-based data that is associated with said one or more components, said component-based data comprising at least one of said stored procedure identifiers and at least one sample time; and
one or more instructions, executable by said processor, that correlate said database data and said component-based data based on a particular one of said stored procedure identifiers, said at least one execution start time, said at least one execution end time, and said at least one sample time that is associated with said particular one of said stored procedure identifiers.

17. The data processing system of claim 16 wherein said one or more instructions determines that said database data and said component-based data are correlated based on said at least one sample time that is associated with said particular one of said stored procedure identifiers being within said at least one execution start time and said at least one execution end time that is associated with said particular one of said stored procedure identifiers.

18. The data processing system of claim 17 further comprising:
at least one child stored procedure of a particular one of said stored procedures that is associated with said particular one of said stored procedure identifiers, that is identified based on a content of said particular one of said stored procedures, said at least one child stored procedure having a child stored procedure identifier;
wherein said one or more instructions correlate also based on said child stored procedure identifier, and a sample time that is associated with said child stored procedure identifier.

19. The data processing system of claim 18 wherein said component-based data also comprises one or more performance measures, and further comprising:
a display presenting said particular one of said stored procedure identifiers, said at least one child stored procedure identifier, said one or more performance measures that are associated with said particular one of said stored procedure identifiers, and one or more performance measures that are associated with said child stored procedure identifier.

20. The data processing system of claim 16 further comprising:
at least one of said performance measures that are associated with said child stored procedure identifier rolled-up to said particular one of said one or more stored procedures.
